(19) United States
(12) Patent Application Publication
(10) Pub. No.: US 2014/0114792 A1
(43) Pub. Date: Apr. 24, 2014

(54) ELECTRONIC COMMERCE SYSTEM

(71) Applicant: NewTide Commerce, Inc., Denver, CO (US)

(72) Inventors: Bret Matthew Smith, Denver, CO (US); Everett Chase Graves, Boulder, CO (US); Scott Thomas Honig, Denver, CO (US); Brandon Adam Evans, Cambridge, MA (US)

(73) Assignee: NewTide Commerce, Inc., Denver, CO (US)

(21) Appl. No.: 14/058,588

(22) Filed: Oct. 21, 2013

Related U.S. Application Data
(60) Provisional application No. 61/716,246, filed on Oct. 19, 2012.

(51) Int. Cl. G06Q 30/06

(52) U.S. Cl. CPC G06Q 30/0611
USPC 705/26.4

(57) ABSTRACT

The exchange-driven electronic market system disclosed herein allows increasing volume and efficiency of transactions between buyers and sellers in a marketplace. An implementation of the electronic market system includes a method comprising receiving a plurality of sale offers, each sale offer including required revenue values required volume values for a product, determining an offered market price based on the plurality of sale offers, displaying the offered market price to a plurality of buyers, receiving from the plurality of buyers a plurality of conditional offers for purchases (COPs), and completing a plurality of sales transactions, if the combination of one or more of the plurality of COPs meets the combination of one or more of the required revenue values.

### FIELD

Implementations disclosed herein relate, in general, to information management technology and specifically to electronic commerce systems.

### SUMMARY

The exchange-driven electronic market system disclosed herein allows increasing volume and efficiency of transactions between buyers and sellers in a marketplace. An implementation of the electronic market system includes a method comprising receiving a plurality of sale offers, each sale offer including required revenue values and required volume values for a product, determining an offered market price based on the plurality of sale offers, displaying, using a computer interface, the offered market price to a plurality of buyers, receiving from the plurality of buyers, using the computer interface, a plurality of conditional offers for purchases (COPs), determining, using a computer processor, whether a combination of one or more of the plurality of COPs meets a combination of one or more of the required revenue values, and completing a plurality of sales transactions, if the combination of one or more of the plurality of COPs meets the combination of one or more of the required revenue values.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example block diagram representing an electronic commerce system disclosed herein.

FIG. 2 illustrates an alternative example block diagram representing an electronic commerce system disclosed herein.

FIG. 3 illustrates another alternative example block diagram representing an electronic commerce system disclosed herein.

FIG. 3A illustrates another alternative example block diagram representing an electronic commerce system disclosed herein.

FIG. 4 illustrates another alternative example block diagram representing an electronic commerce system disclosed herein.

FIG. 5 illustrates another alternative example block diagram representing an electronic commerce system disclosed herein.

FIG. 6 depicts a flowchart illustrating example operations that facilitate the electronic market system disclosed herein.

FIG. 7 demonstrates an alternative flowchart illustrating example operations that facilitate the electronic market system disclosed herein.

FIG. 8 illustrates an alternative implementation of an exchange driven market system.

FIG. 9 illustrates a method of selecting a flowchart for a method of prequalifying sellers based on one or more buyer preferences.

FIG. 10 illustrates a flowchart for generating an effective COP and an effective CMP for each seller based on a buyer's COPs.

FIG. 11 illustrates a block diagram of an alternative implementation of an exchange driven market system including physical storefront locations.

FIG. 12 illustrates an example of seller input for a required revenue model that dictates if and when aggregate transactions can occur.

FIG. 13 illustrates a required revenue model consisting of a current single sale offer vs. number of previous sales in a given timeframe graph and a required revenue vs. number of future sales graph for various sellers.

FIG. 14 illustrates an example computing system that can be used to implement the exchange driven market system disclosed herein.

### DETAILED DESCRIPTION

The exchange-driven electronic market system disclosed herein allows increasing volume and efficiency of transactions between buyers and sellers in a marketplace. Specifically, the electronic market system facilitates the buying/selling of discretely defined products and/or services between one or more buyers and one or more sellers. An implementation of the electronic market system allows buyers to place conditional offers for purchase (COP) for products and/or products and sellers to input required revenue models. The required revenue models may provide volume of products that the seller is willing to sell at various price points. The electronic market system uses the offer price/volumes and the COPs for the automation of transactions at mutually agreeable prices. Aggregate transactions occur when a combination of a certain number of standing COPs provides the required amount of revenue for a seller or a combination of sellers for a certain number/volume of products sold. Sellers fill individual or certain amounts of COPs by adjusting their required revenue model.

An implementation of the market tracks the substantially lowest price a buyer may have to pay to complete a mutually agreeable transaction, as well as the substantially lowest price a buyer may have to pay to complete a mutually agreeable aggregate of transactions, and displays this price to the buyer as the current market price (CMP). In one implementation of the market, aggregate transactions occur when a combination of a certain number of standing COPs and a buy offer at the CMP provides the required amount of revenue for a seller or combination of sellers for a certain number/volume of products sold. For example, when the CMP is the least amount needed to complete an aggregate transaction, a purchase by the buyer at the CMP may provide enough revenue to include some or all standing COPs in an aggregate transaction.

An implementation of the electronic market system includes a process to maximize the volume of sales when multiple aggregate transactions are possible.

Alternatively, the electronic market system includes processes for allowing buyers and sellers to dictate the terms of transactions including but not limited to the method of shipping, location of the seller, customer service rating of the seller, additional services that the seller provides, and return policies. Furthermore, the electronic market system may also include a process for maintaining a buyer-generated feedback system, which affects the ratings of the seller.

Yet another implementation of the electronic market system includes a process for awarding sales to sellers in the event of a tie based on buyer-specified tiebreakers. The electronic market system includes processes to incorporate the cost of applicable sales tax and the seller cost of shipping into the transaction. Yet alternatively, the electronic market system includes a process for the injection of capital into a transaction or aggregate of transactions or reduction of transaction fee to allow the transaction or aggregate of transactions to occur when it otherwise would not occur because a gap between the aggregate bid and offer prices would have prevented buyer(s) and seller(s) to meet mutually agreeable terms.

Yet another implementation of the electronic market system includes a process for awarding sales to sellers in the event of a tie-breaker based on the sellers required revenue model. Specifically, the electronic market system selects a seller that will sell the next product at the lowest price compared to the sale offers from the other sellers. Such selection based on the sales price of the next product may continue as long as the price of such next product allows such tie-breaking For example, if a sale that needs tie-breaking is for n products, the sale price for n+1^{st} product is used for tie-breaking. If the sale offer for the n+1^{st} product is the same from two sellers, the sale price for the n+2^{nd} product is used for tie-breaking, etc.

Another implementation of the electronic market system includes a process for displaying a seller's current offering price for a good and/or service in a physical storefront location using electronic displays which are based on the seller's required revenue model. The electronic displays track the seller's required revenue model and display current offering prices in a storefront location, which are instantaneously updated according to the seller's provided pricing model.

One or more of the above processes of the electronic market system increase the volume and efficiency of transactions through the automation of providing buyers and sellers with mutually agreeable transactions across a range of terms and conditions, and allowing the instantaneous consequences of seller(s)' and buyer(s)' offers to be known.

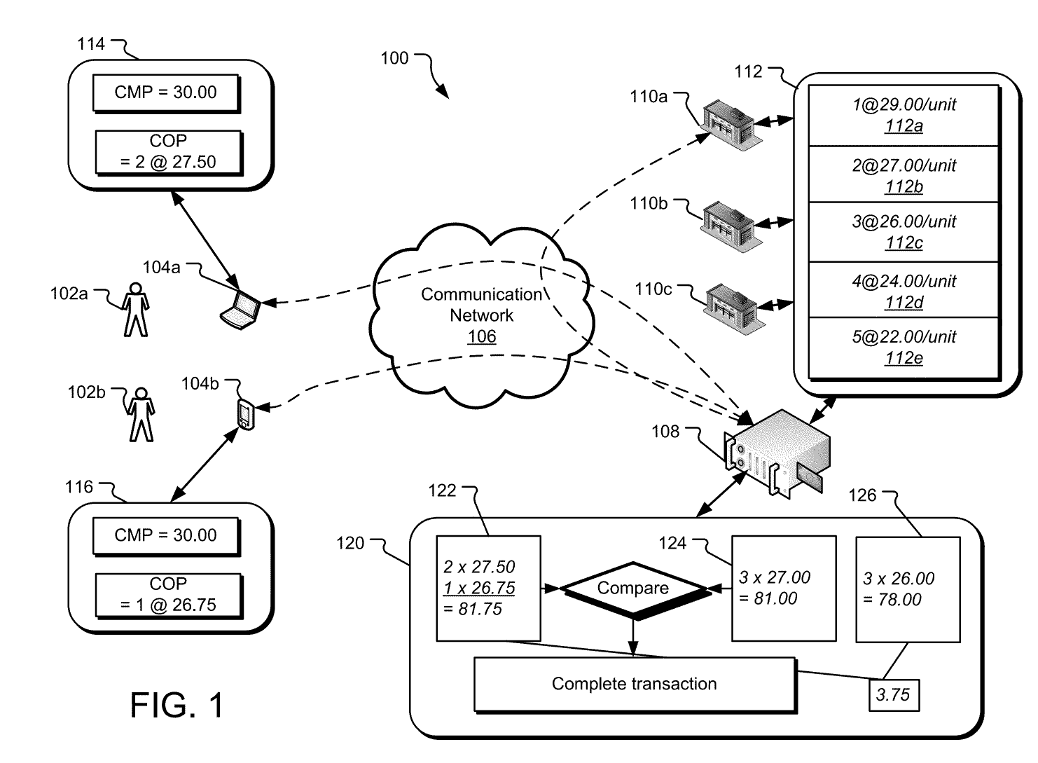

FIG. 1 illustrates an example implementation of an electronic market system 100. The electronic market system 100 allows a plurality of buyers 102a, 102b (collectively 102) to participate in the market using devices 104a, 104b, etc., (collectively 104). For example, the devices 104 include a laptop, a desktop, a smartphone, a tablet device, etc. One or more sellers 110a, 110b, 110c (collectively 110) may participate in the electronic market system 100 using various seller devices (not shown) similar to the devices 104. The electronic market system 100 may be implemented on a server 108. Alternatively, the electronic market system 100 may be implemented on a cloud system including a plurality of communicatively connected servers. Furthermore, the devices 104, the seller devices, the server 108, etc., are communicatively connected to each other via a communication network 106. The communication network 106 may be, for example, the Internet.

The electronic market system 100 allows various sellers 110 to input sale offers for various products. For example, suppose that the sellers 110 are in the business to sell widgets. The offer price for the widgets generally depends on the production cost, purchase price, and other costs of the sellers 110. Furthermore, as the production of the widgets increases, the production cost for the widgets generally decreases due to allocation of fixed costs to the number of widgets. As sellers 110 are in the market to generate profit on their sale of widgets, the price of the widgets offered by the sellers 110 also depends on the quantity of the widgets sold. Thus, for example, the seller 110a may be willing to sell one widget at the price of $29.00 per widget. However, if the seller is able to sell 2 widgets, the offered sale price decreases to an average of $27.00 per widget, etc. For example, the seller 110a may be willing to sell 3 widgets at $26.00 per widget, 4 widgets $24.00 per widget, and 5 widgets at $22.00 per widget. In an alternative implementation, the price per unit may decrease until a given quantity of sales and then increase thereafter, reflecting a response to high demand, scarcity of production, etc.

Note that in the illustrated implementation here the sale offer prices 112 are illustrated as provided by a plurality of sellers 110. Each of the offer prices 112a, 112b, 112c, 112d, 112e are the lowest of the offers from each of the sellers 110. For example, the seller 110a may be willing to sell four widgets at $26 per widget, seller 110b is willing to sell four widgets at $24 per widget, and seller 110c is willing to sell four widgets at $25 per widget. The offer prices 112 are generated as the lowest offer from each of the sellers 110 for a given volume (so the offer price for 4 widgets is seller 110b's offer of $24 per widget).

The electronic market system 100 uses the offer prices 112 to generate a current market price (CMP). In determining the CMP, the electronic market system 100 takes into consideration its intermediary fees. For example, in the illustrated implementation, the electronic market system 100 uses the lowest price for one widget from all the sellers 110, which is $29 for one widget and adds one dollar for its intermediation fees, to generate a CMP of $30.

Furthermore, if more than one seller is offering one widget at the same price, the electronic market system 100 uses some alternative criteria to determine which seller's widgets are sold. For example, the seller reputation, seller's ranking based on buyer feedback, the tax and shipping costs based on the seller's location with respect to the buyer's location, etc., may be used in determining which seller's widgets are to be sold to the buyers 102. In one implementation, the electronic market system 100 determines which seller's widgets are sold by awarding the sale to the seller who requires the least amount of revenue for subsequent sales. For example, if both sellers 110a and 110b are offering to sell five widgets for an average of 29 dollars per unit, and that sale is possible based on the COPs, the sale will be awarded to the seller who has the lowest price for the 6^{th} unit. That way, prices are lower for the subsequent consumers. Furthermore, if the prices for the 6^{th} unit are also the same, the price for the 7^{th} unit is evaluated, etc.

In one implementation, the offer prices 112 may also include other incidental expenses involved in completing a sale transaction, such as taxes, shipping charges, etc. Alternatively, the offer prices 112 may only include the widget price with the taxes, shipping, warranty, insurance, etc., to be offered to the buyer 102 at additional cost. The entity handling such incidental costs may also vary. For example, in one implementation, the electronic market system 100 may act as an intermediary that provides all of these incidental services to the buyers 102 and charges the buyers 102 accordingly. Alternatively, once a transaction is initiated between the buyers 102 and the sellers 110, the sellers 110 are charged to handle such incidental services and charge the buyers 102 for the same.

In the illustrated example, for each widget sold purchased by the buyers 102, the electronic market system 100 will generate one-dollar intermediation fees. Note that in one implementation, such intermediation fee may also be dependent on the volume of widgets sold. Thus, the sale of the first two widgets may be charged $1 intermediation fee per widget, whereas the next three widgets may be charged $0.75 intermediation fee per widget, etc.

The electronic market system 100 displays the CMP to the buyers 102 as the offered price for the widget. For example, when the buyers 102 access a website or an app, (such as a mobile app for use on a mobile device) provided by the electronic market system 100 using devices 104, the CMP is displayed on the GUIs 114, 116 of such website app, etc. The GUIs 114, 116 also allows the buyers 102 to input the price they are willing to pay for the widget for a given quantity of widgets to be purchased. The combination of the price and quantity provided by the buyers 102 is referred to as the conditional offers for purchase (COP). For example, the buyer 102a may input a COP of two widgets at $27.50 whereas the buyer 102b inputs a COP of one widget at $26.75.

As the offer prices of $29.50 and $26.75 each are lower than the CMP of $30, generally the transaction of each individual buyer 102a and 102b may not be completed. However, the electronic market system 100 aggregates the COPs from various buyers 102 and compares the aggregate COPs with the offer prices 112 to make a decision as to whether one or more transaction are to be completed. An analytic 120 illustrates the analysis performed by the electronic market system 100.

Specifically, the analytic 120 includes calculation of total purchase price 122 resulting from the COPs, the required revenues 124 to the electronic market system 100 (which includes the required revenues to the seller as well as any intermediary fees including the market system transaction fees, and/or other incidental expenses involved in completing a sale transaction, such as taxes, shipping charges, etc.) and the required seller revenues 126 to the sellers. In the particular example illustrated here, the total purchase price 122 is $81.75, which is higher than the total required revenue 124, which is $81. As a result, the comparison of the total purchase price 122 and the total required revenue 124 results in a completed transaction between the buyers 102 and the sellers 110. The analytics 120 also illustrate that for the quantities of widgets that are subject to the transaction, the resulting seller revenues 126 to the sellers is $78.00, thus resulting in $3.75 of intermediation income for the electronic market system 100. The resulting intermediation income of $3.75 includes $3.00, that is $1.00 per widget for three widgets sold, of transaction fee and $0.75 of additional profit to the electronic market system 100 due to the difference between the total purchase price 122 of $81.75 and the total required revenue 124 of $81.00.

Once the transaction has occurred, the electronic market system 100 adjusts various parameters. For example, once the transaction of the three widgets is completed as illustrated in FIG. 1, the electronic market system 100 reviews remaining purchase prices from the sellers to generate another CMP that will be displayed to the buyers 102. For example, now that the seller with the lowest purchase price for the three widgets has completed a sale of those three widgets, the offering price 112 may be adjusted to reflect the updated lowest sale offers for subsequent volumes of transactions.

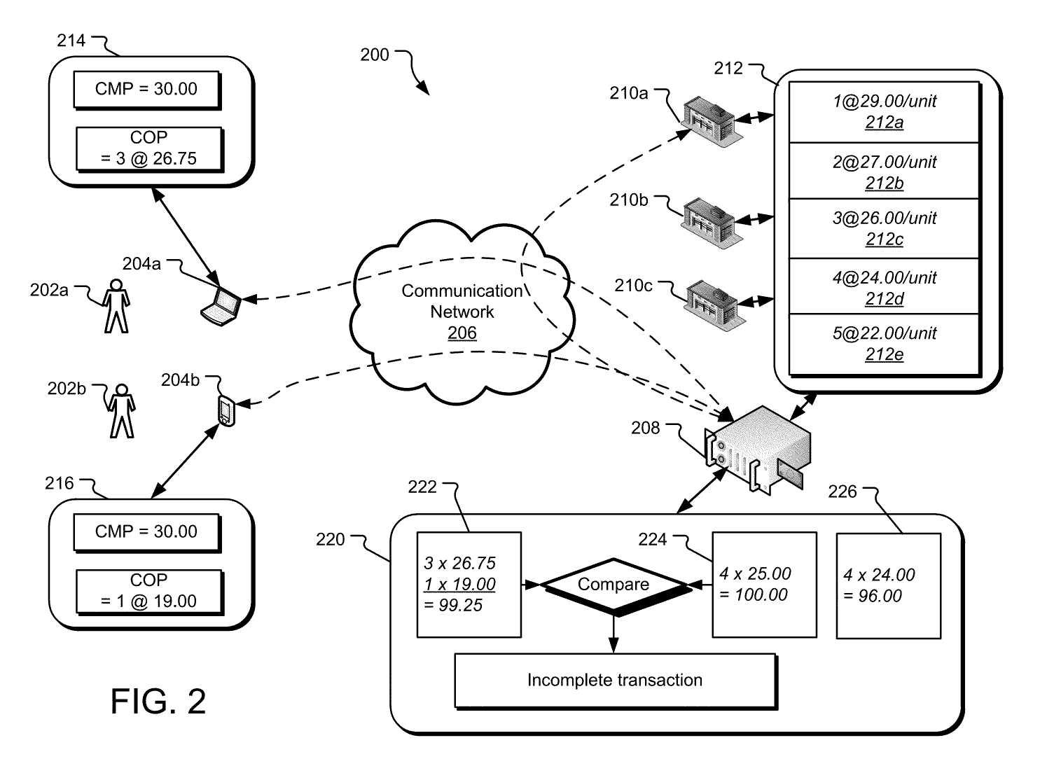

FIG. 2 illustrates an alternative example of the electronic market system 200 that facilitates transactions between buyers 202 and sellers 210. Specifically, the various components of the electronic market system 200 are substantially similar to the respective components discussed with respect to the electronic market system 100. However, the example of the electronic market system 200 illustrates an alternative outcome based on inputs received from various buyers 202. For example, the purchase prices 212 provided by the various sellers in the example electronic market system 200 result in the CMP of $30 for the widgets. However, the COPs offered by the buyers 202a and 202b are different.

Specifically, in this example, the buyer 202a offers a COP of three widgets at $26.75 each and the buyer 202b offers a COP of one widget at $19.00 each. As shown by the analytic 220, the resulting total purchase price 222 is $99.25 for four widgets, which is less than the total required revenue 224 of $100.00. As a result, the COPs offered by the buyers 214 and 216 do not materialize into a transaction.

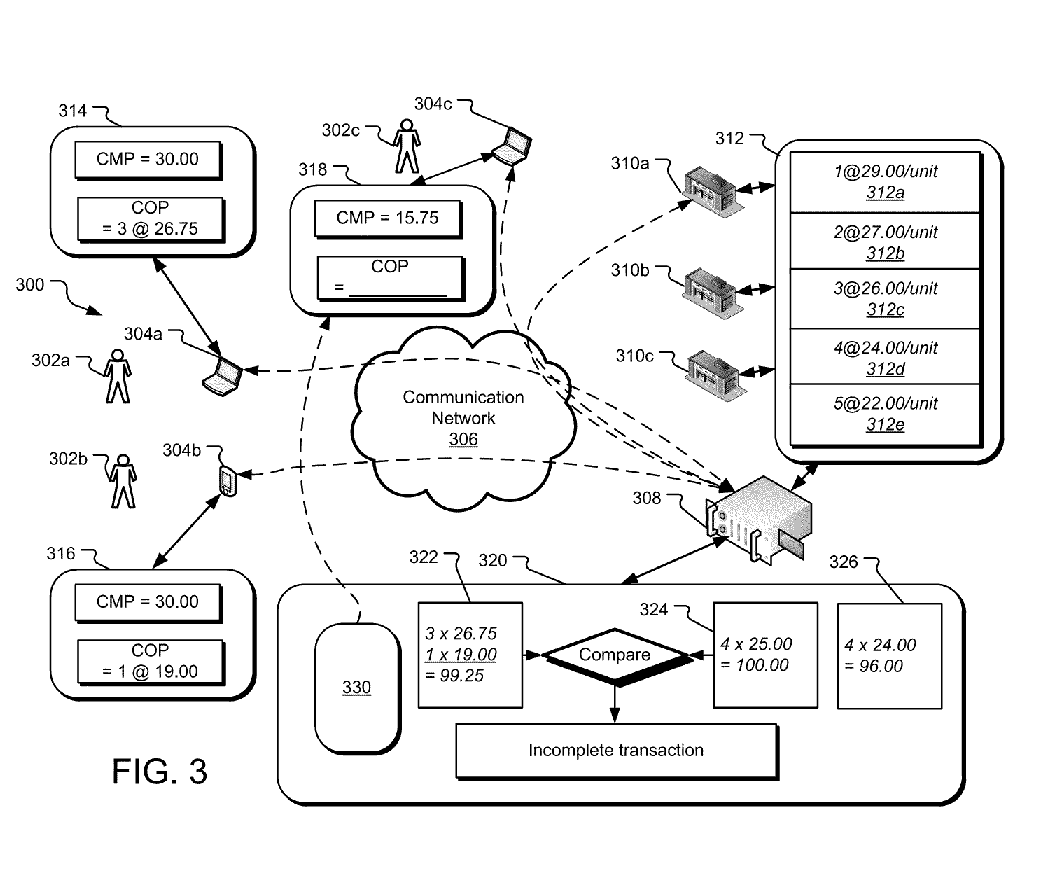

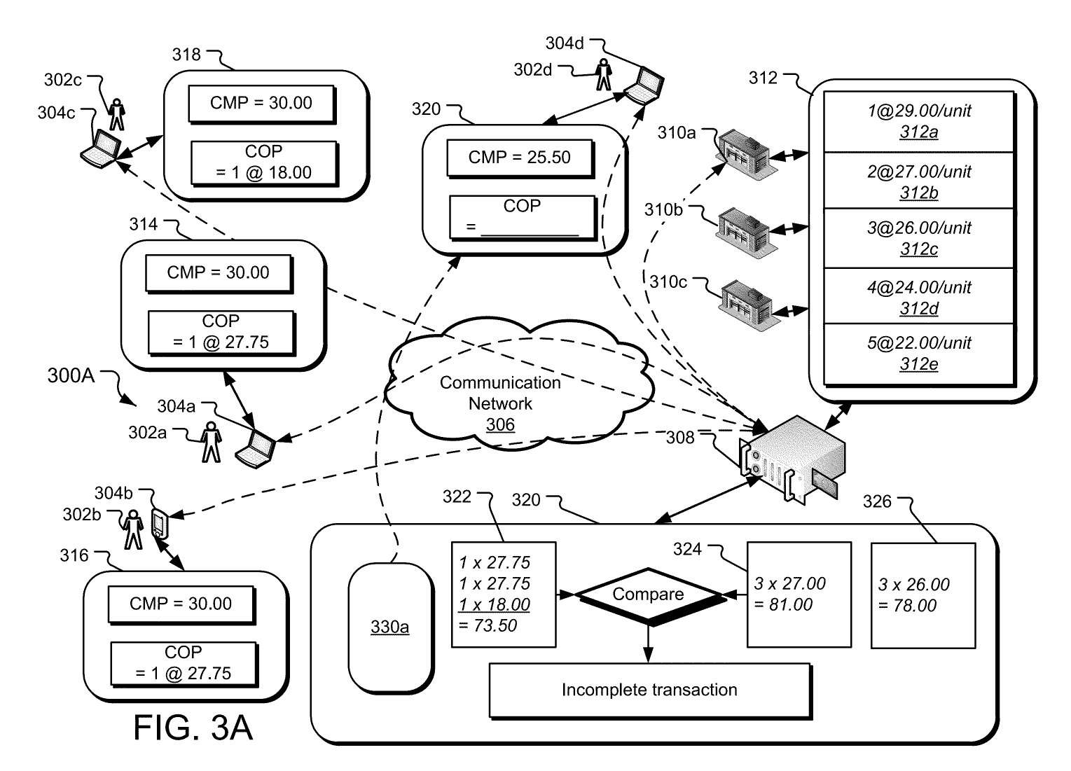

FIG. 3 illustrates an alternative example of the electronic market system 300 that facilitates transactions between buyers 302 and sellers 310. Specifically, the electronic market system 300 illustrates a method of adjusting CMPs that may be used by the electronic market system 300 when COPs offered by the buyers do not result into a transaction. Specifically, a CMP update analytic module 330 determines an additional buy offer for a transaction with an additional buyer required to complete an aggregate transaction together with the currently offered COPs by the existing buyers. Such additional buy offer is displayed to an additional buyer 318 as an updated CMP. In the illustrated example, such additional buy offer of $15.75 from a new buyer 302c would result in the required revenue to complete an aggregate sale of five widgets. Specifically, given the current value of the total offer price 322 of $99.25 for four widgets and the seller offer of selling five widgets at $22.00 each, resulting in $115 of total required revenue ($22.00×5=$110.00, plus $5.00 of transaction fee payable to the electronic market system 300), the minimum additional buy offer price needed to complete an aggregate sale is $115.00−$99.25=$15.75. The electronic market system 300 displays the minimum additional buy offer of $15.75 as the CMP to the buyer 302c. In this case, if the buyer 302c accepts the CMP, the aggregate transaction between buyers 302 and the sellers 310 is completed. Such completed transaction would generate revised total offer price 322 of $115.00, revised total require revenue 324 of $115.00, and revised resulting seller revenue of $110.

FIG. 3A illustrates an alternative example of the electronic market system 300A that facilitates transactions between buyers 302 and sellers 310. Specifically, the electronic market system 300 illustrates a method of adjusting CMPs that may be used by the electronic market system 300 when COPs offered by the buyers do not result into a transaction. Specifically, a CMP update analytic module 330a determines an additional buy offer for a transaction with an additional buyer required to complete an aggregate transaction together with less than all of the currently offered COPs by the existing buyers.

In the example illustrated in FIG. 3A, there are three outstanding COPs 314, 316, and 318 from buyers 302a, 302b, and 302c that result in total purchase offer 322 of $73.50. Note that the effective required revenue 326 for three widgets is $78.00, thus the existing COPs results in an incomplete transaction. However, in the present case, the effective required revenues for four sales is $100.00 (four widgets at $24.00 per widget, plus $1.00 transaction fee per widget). Thus, a purchase from a fourth buyer 302d at $26.50 would result updated total purchase offer 322 of $100.00 that would result in a completed transaction, generating $4.00 of intermediation fee to the market. Thus, CMP₁ of $26.50 may be used as CMP offered to the buyer 302d.

However, in the present case, the analytic 330a also calculates alternative values of total purchase offers 322 if less than all COPs 314, 16, and 318 are used with an additional purchase from the buyer 302d. For example, if the two highest COPs 314 and 316 are used (each for one widget at $27.75), the updated total purchase offer 322 comes to be 55.50. In this case, the updated effective required revenues 326 for three widgets is $81.00 (three widgets at $26.00 per widget, plus $1.00 transaction fee per widget). Therefore, a purchase from the buyer 302d at $25.50 would result in completed transaction, giving CMP₂ of $25.50, which may be used as CMP offered to the buyer 302d.

Similarly, the analytic 330a also calculates alternative values of total purchase offers 322 if only one of the highest COPs ($27.75) were used. (The selection of COP 316v. 314, both having the same COP may be done based on other factors such as buyer rating, timing of receiving the COPs, etc.). In this case, the updated total purchase offer 322 comes to be 27.75. In this case, the updated effective required revenues 326 for two widgets is $56.00 (three widgets at $27.00 per widget, plus $1.00 transaction fee per widget). Therefore, a purchase from the buyer 302d at $28.25 would result in completed transaction, giving CMP₃ of $28.25, which may be used as CMP offered to the buyer 302d.

The analytic 330a compares each of the three candidate CMP values (CMP₁, CMP₂, and CMP₃) and selects the smallest of the three, in this case, CMP₂ of $25.50 for the additional buyer 302d. Alternatively, other criterion, such as highest intermediation fee to the electronic market system 300A, etc., may be used.

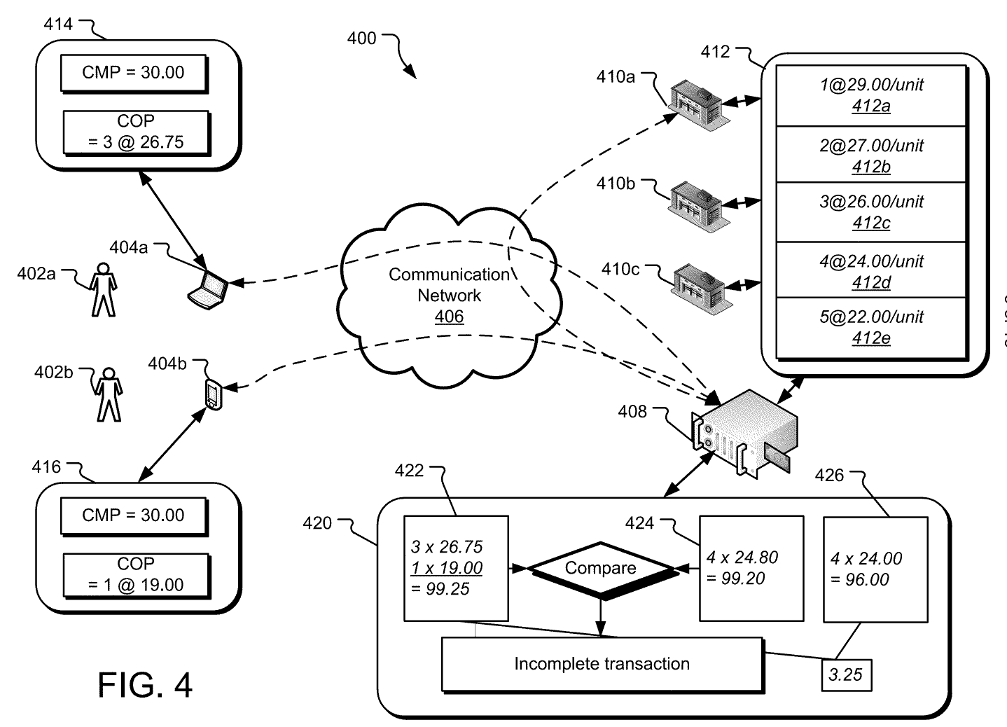

Now referring to FIG. 4, it illustrates yet another example of the electronic market system 400 that facilitates transactions between buyers 402 and sellers 410. Specifically, the various components of the electronic market system 400 are substantially similar to the respective components discussed with respect to the electronic market systems 100, 200, and 300. However, the example of the electronic market system 400 illustrates an alternative outcome based on the intermediation costs applied by the electronic market system 400.

Note that based on the offer prices 412 from the sellers 410 and the COPs offered by the buyers 402, the total resulting purchase price 422 is $99.25 for four widgets, which would be less than the total required revenue 424, if the electronic market system 400 were to apply $1 of intermediation fee per widget. However, in this example, the electronic market system 400 adjusts the intermediation fee based on the values of the total resulting purchase price 422 and the total required revenue 424. Specifically, the electronic market system 400 reduces the intermediation fee to $0.80 per widget, resulting in the total required revenue 424 to be equal to $99.20. Subsequently, because the total resulting purchase price 422 is higher than the total required revenue 424, the electronic market system 400 is able to complete the transaction. As illustrated by the analytic 420, as a result of these transactions, the resulting seller revenue 426 equals $96 with the total intermediation income of $3.25 for the electronic market system 400.

While the example electronic market system 400 provides for adjusting the intermediation fee for the electronic market system 400, in an alternative implementation, other parameters of the electronic market system 400 may be varied. For example, in one implementation, the electronic market system 400 may input additional capital of its own to ensure that a transaction is completed.

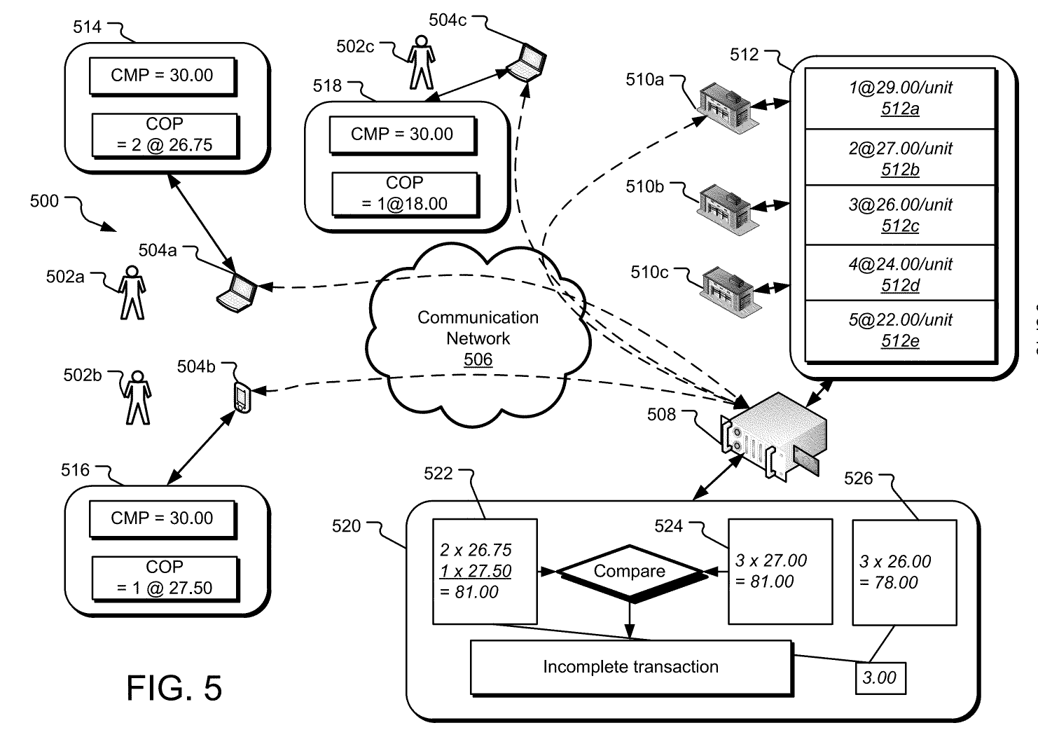

FIG. 5 illustrates yet another implementation of an electronic market system 500 that facilitates transactions between buyers 502 and sellers 510. Specifically, the various components of the electronic market system 500 are substantially similar to the respective components discussed with respect to the electronic market systems 100, 200, 300, and 400. However, in the illustrated implementation of the electronic market system 500, offers from less than all buyers 502 are used in completing a transaction between the buyers 502 and the sellers 510.

In the illustrated implementation of the electronic market system 500, a buyer 502a offers a COP of two widgets at $26.75, a buyer 502b offers a COP of one widget at $27.50, and a buyer 502c offers a COP of one widget at $18.00. In this case, the analytic 520 evaluates various combinations of the COPs 502a, 502b, and 502c, against the sale offers from the buyers 510. In this implementation, the analytic 520 determines that the resulting total purchase price 522 of $81.00 based on COPs from buyers 502a and 502b satisfies the total required revenue 524 of $81.00 for three widgets. As a result, the COP offered by the buyer 502c is not used in completing the transaction for widgets.

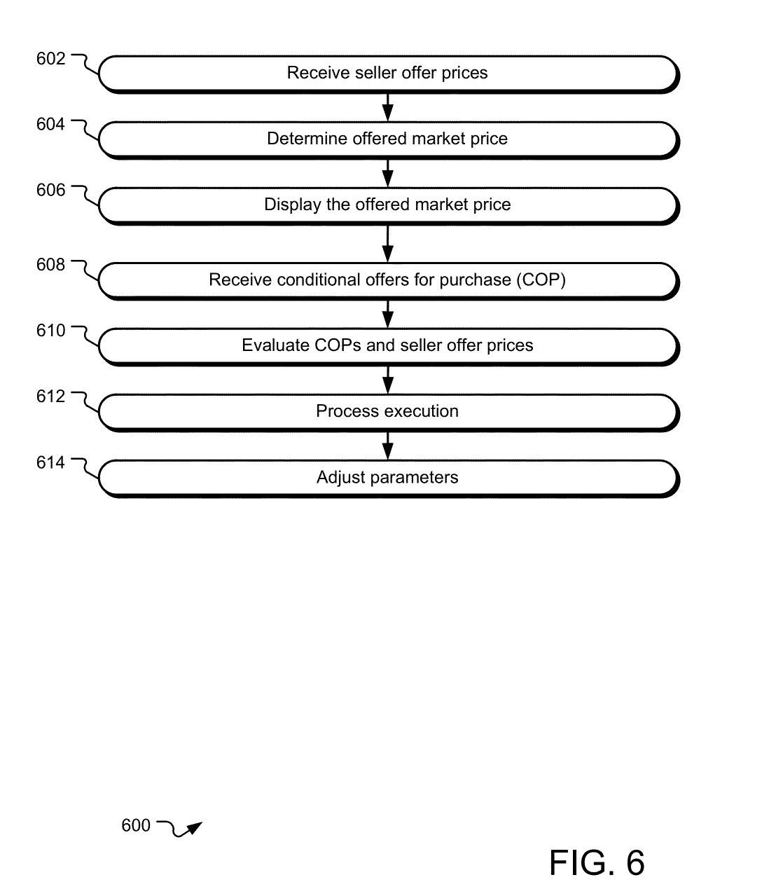

Now referring to FIG. 6, it illustrates a flowchart 600 illustrating example operations that facilitate the electronic market system disclosed herein. Specifically, an operation 602 receives offer prices from various sellers for a discretely defined product, such as gadgets. For example, the operation 602 may provide a GUI via a website, an app, an enterprise application, etc., that can be used by the sellers to input their offer prices. In one implementation, the sellers provide the input price in terms of the number of gadgets offered at particular price level. Table I below provides an example of such offer price input from two different sellers for the gadget:

TABLE I

| Number of | Seller A Offer Price | Seller B Offer Price | Best Offer Price |
|---|---|---|---|
| Gadgets | Per Gadget | Per Gadget | Per Gadget |
| 1 | $29.00 | $30.00 | $29.00 |
| 2 | $28.00 | $29.00 | $28.00 |
| 3 | $27.00 | $26.00 | $26.00 |
| 4 | $26.00 | $24.00 | $24.00 |
| 5 | $25.00 | $22.00 | $22.00 |

Subsequently, an operation 604 determines the offered market price for the gadget based on the offer prices from the sellers. For example, in the above example, supposing that there are no intermediation fees to be charged by the electronic market system, the lowest price for the smallest number of gadgets, which is equal to $29.00 for one gadget, is determined to be the market price.

Subsequently, an operation 606 displays the offered market price to a number of buyers. For example, the electronic market system may use a server with applications that relates the market price for various products and when a buyer selects a product using a website, a mobile app, etc., the server selects the appropriate market price and displays it to the GUI used by the buyer to access such server. In one implementation, the displaying operation 606 displays the market price at a storefront using electronic displays.

As discussed above with respect to the electronic market system 600, in one implementation, the offered market price to an additional buyer is the substantially lowest market price required to complete an aggregate sale between the buyers, including the existing buyers and the additional buyer, and the sellers.

In one implementation, the GUI, such as a browser, an application GUI, etc., that is used to display the market price also allows the user to input conditional offer for purchase (COPs). An operation 608 receives such COPs from the buyers. A buyer may provide a COP that ties the purchase price to a volume of purchase. For example, table II below provides the COPs received from three buyers in response to the market price of $29.00 per gadget.

TABLE II

| | Conditional Offer for Purchase (COPs) | | |
|---|---|---|---|
| Buyer | Gadgets | Price per Gadget | Effective Total |
| A | 1 | $28.00 | $28.00 |
| B | 2 | $23.00 | $46.00 |
| C | 1 | $22.00 | $22.00 |
| Total | 4 | | $96.00 |
| Average | | $24.00 | |

In an alternative implementation, the receiving operation 608 also receives other information from the buyers such as buyer preferences including but not limited to the preferred method of shipping, the maximum amount that the buyer is willing to pay for the shipping, a customer service rating of various sellers, acceptable return policies, etc. The electronic marketplace stores various seller parameters that can be evaluated with respect to such buyer preferences to determine whether a seller offer should be considered to meet a buyer's COP. Additional parameters such as user feedbacks, etc., can also be taken into consideration.

While table II illustrates the COPs as provided by the buyers using a GUI, etc., alternatively, the electronic market system may calculate effective COP per seller based on the COP provided by the buyers. For example, the system may determine COP per seller basis for a particular client, taking into account the shipping cost, tax, etc., effective between that particular combination of buyer and seller. Subsequently, such effective COP is used in evaluating the volume based COPs compared to seller offer prices.

Note that while operation 608 is illustrated to receive COPs from the buyers for further processing, in an alternative implementation, the CMP displayed by the system is also offered as the instantaneous transaction price. Thus, if a buyer is interested in buying the gadget at $29.00, which is the CMP based on the lowest offer price, the buyer will able to execute such transaction instantaneously.

An operation 610 evaluates the COPs received from the buyers to determine whether to complete a transaction. In the above case, the evaluating operation 610 determines the effective COP to be four gadgets at $24.00 per gadget. Such a COP would satisfy seller B's offer price of four gadgets at $24.00 per gadget. Alternatively, if the total of all the buyer COPs result in effective COP of 4 gadgets at $23.00, such COP would not satisfy any seller's offer price. On the other hand, if the total of all the buyer COPs result in effective COP of four gadgets at $26.00 such COP would satisfy offer prices from both seller A (four gadgets at $26.00) and seller B (four gadgets at $24.00), in which case, the operation 610 selects the lower offer price from seller B to execute the transaction. In such a case, the difference between the COP of $26.00 per gadget and the offer price of $24.00 per gadget is the profit accruing to the electronic market system. In some implementations, such profit is divided between the electronic market system and the seller B based on some pre-existing contract. Alternatively, the electronic market system may keep the profit as part of its fees for facilitating the transactions based on volume.

The COPs provided in Table II compared to the offer prices provided in Table I illustrate that the exchange driven electronic marketplace disclosed herein allows for a volume transaction to occur between a plurality of buyers and a plurality of sellers when if each buyer had to execute the transaction individually with one of the sellers, such transaction would not have occurred. For example, none of the sellers would have been able to supply one gadget at $28.00, two gadgets at $23.00, etc. However, because the electronic market system aggregates the COPs from the buyers, the aggregated COPs are able to meet the offer prices from the sellers. Furthermore, the electronic market system aggregates the COPs and awards such COPs to the sellers so as to maximize the volume of transactions in the marketplace.

Table III below provides an alternative example of offer price input from two different sellers for the gadget and Table IV below provides the COPs received from three buyers in response to the offered market price determined based on Table III.

TABLE III

| Number of | Seller A Offer Price | Seller B Offer Price | Best Offer Price |
|---|---|---|---|
| Gadgets | Per Gadget | Per Gadget | Per Gadget |
| 1 | $30.00 | $30.00 | $30.00 |
| 2 | $29.00 | $27.00 | $27.00 |
| 3 | $26.00 | $26.00 | $26.00 |
| 4 | $24.00 | $25.00 | $24.00 |
| 5 | $22.00 | $24.00 | $22.00 |

TABLE IV

| | Conditional Offer for Purchase (COPs) | | |
|---|---|---|---|
| Buyer | Gadgets | Price per Gadget | Effective Total |
| A | 1 | $28.00 | $28.00 |
| B | 1 | $24.00 | $24.00 |
| C | 1 | $27.00 | $27.00 |
| Total | 3 | | $79.00 |
| Average | | $26.33 | |

In the example illustrated above, as the evaluating operation 610 determines that the effective COPs from the buyers adds up to be three units at $79.00, the offer prices from each of the sellers A and B meets such COP. In such a case, the evaluating operation 610 may use some alternative or tie-breaking criterion for determining whether seller A or seller B is going to fulfill the particular order. For example, the evaluating operation 610 may award the sale to the seller that has the lowest offering price for a subsequent sale after the aggregate transaction. In the illustrated example, seller A will sell four units for an average price of $24 per unit, and seller B will sell five units for an average price of $25 per unit. Thus, seller A is awarded the sale. In an alternate implementation, the evaluating operation 610 may use other parameters such as the reputation of the sellers, a customer satisfaction rating of the seller, etc., to determine which seller is going to fulfill such COPs. In an yet another alternative implementation, the evaluating operation 610 may use other parameters such as shipping cost, resulting sales tax to the buyers, etc., in selecting the seller offer that is going to match the COPs.

Subsequently, an operation 612 executes the transaction between the seller selected to fulfill the order for the gadgets and the buyers. In one implementation, such executing the transaction may include the electronic market system purchasing the gadgets from the seller at $26.00 and selling them to the buyers for $26.33. In such a case, the electronic market place handles the shipping, taxes, etc. In an alternative implementation, the electronic market place allows the selected seller to execute the transaction directly with the seller in which case, the seller is responsible for shipping and handling, collecting taxes, etc.

Subsequently, an operation 614 adjusts the offered market price, the COPs, etc., based on the executed orders, the available gadgets, etc. For example, suppose seller A has sold three gadgets at an average price of 26.00 per gadget (resulting in total revenue of $96.00) and given that seller A has offered to sell four gadgets at $24.00 (resulting in total required revenue of $96.00), seller A can now sell the next gadget for $18 ($96.00−$78.00) and still meet the total required revenues for four gadgets. Thus, the new CMP is $18.00.

Alternatively, the electronic marketplace may add additional sellers of gadget A to Table I to generate a new supply table. If the market prices are displayed in storefront displays, such displays are changed automatically to reflect the changed current market prices. Thus, the updated required revenue models provided by the sellers are used to automatically update the current offering prices. Such updates to the required revenue models may also account for canceled transactions, returns, etc. For example, if a seller receives returns for five gadgets, the seller can update his offer price to reflect the additional inventory due to returned gadgets.

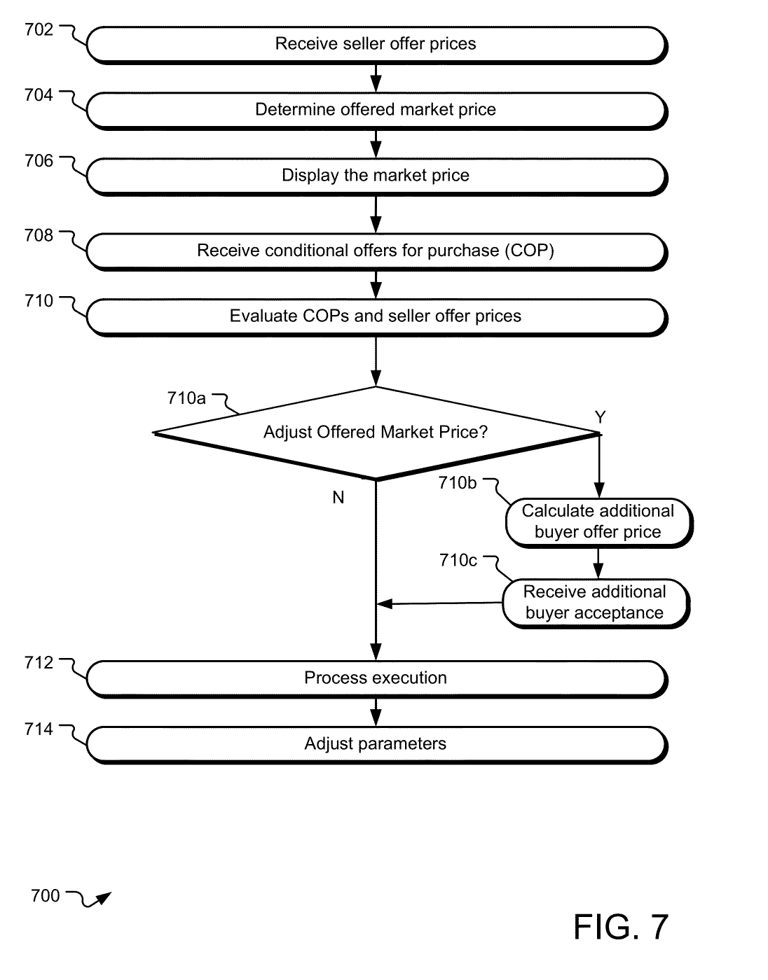

FIG. 7 illustrates a flowchart 700 illustrating alternative example operation that facilitate the electronic market system disclosed herein. Various operations of the flowchart 700 are substantially similar to the related operations in flowchart 600 and therefore, are not discussed in substantial detail here. However, the flowchart 700 allows adjusting the offered market price to one or more additional buyers based on the existing COPs and the existing total required revenues.

Specifically, an operation 710a determines if such adjusting of the offered market price to one or more additional buyers is necessary. The operation 710a may make such determination if the total of the existing COPs do not meet the total required revenues. An operation 710b calculates such additional buyer offer price. Such additional offered market price may be, for example, the substantially lowest purchase price that would result in completing transactions. For example if existing COPs result in total purchase price of pₙ for n widgets and the total required revenues for n+1 widgets is rₙ₊₁, the additional offered market price maybe equal to rₙ₊₁−pₙ. In one implementation, an operation 710b determines the substantially lowest additional buyer offer price to complete an aggregate transaction by the following method:
1. Determine pₙ, which is the total purchase price for n widgets from the n existing COPs. Determine rₙ₊₁, which is the total required revenue for n+1 widgets. Determine the additional offered market price (rₙ₊₁−pₙ) required to complete n+1 sales. Store the value for the additional offered market price as mₙ₊₁.
2. Determine pₙ₋₁, which is the total purchase price for n−1 widgets from the greatest n−1 existing COPs. Determine rₙ, which is the total required revenue for n widgets. Determine the additional offered market price (rₙ−pₙ₋₁) required to complete n sales. Store the value for the additional offered market price as mₙ.
3. Determine pₙ₋₂, which is the total purchase price for n−2 widgets from the greatest n−2 existing COPs. Determine rₙ₋ᵢ, which is the total required revenue for n−1 widgets. Determine the additional offered market price (rₙ₋₁−pₙ₋₂) required to complete n−1 sales. Store the value for the additional offered market price as mₙ₋₁.
   . . . (repeat iteratively)
4. Determine p₁, which is the total purchase price for 1 widget from the greatest existing COP. Determine r₂, which is the total required revenue for 2 widgets. Determine the additional offered market price (r₂−p₁) required to complete 2 sales. Store the value for the additional offered market price as m₂.
5. Determine r₁, which is the total required revenue for 1 widget.
6. Update the CMP to reflect the lesser of r₁, m₂, m₃, . . . mₙ₊₁.

Subsequently, an operation 710c receives an acceptance from the additional buyer for a purchase at the additional offered market price (updated CMP), resulting in processing of transaction by an operation 712.

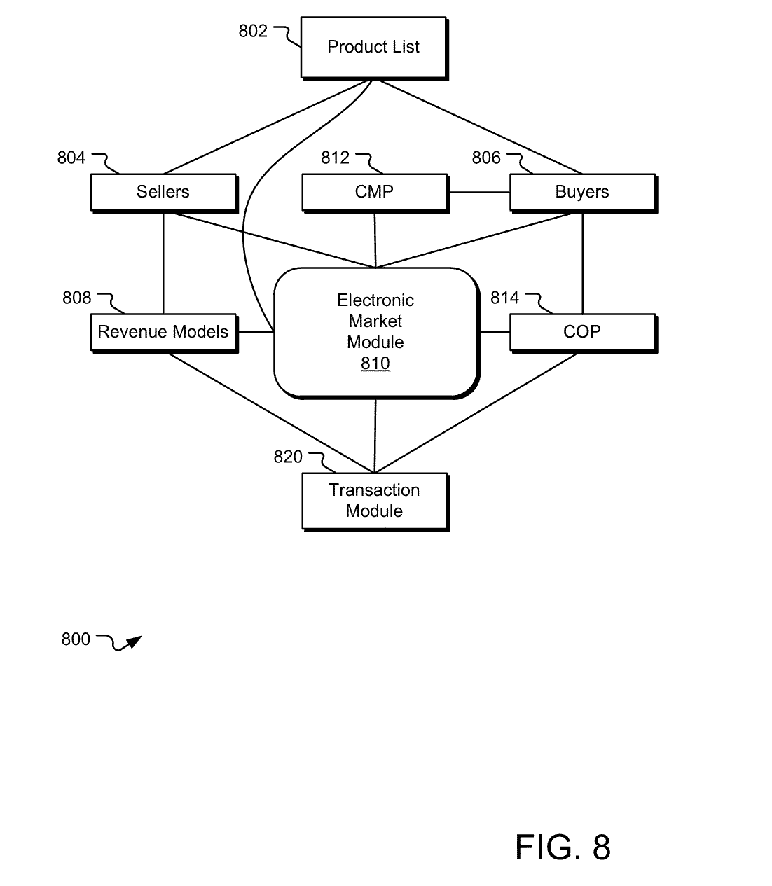

FIG. 8 illustrates an alternative implementation of an exchange driven market system 800. The exchange driven market system 800 includes a server 802 that stores a database of discretely defined products. Such discretely defined products, such as gadgets, widgets, etc., allow sellers 804 to easily identify the number of products they are selling at per unit price and the buyers 806 can specify the number of product that they are willing to purchase at a given per unit price.

The exchange driven market system 800 receives required revenue models 808 from the sellers 804 where the required revenue model is provided per product. Thus, there may be one required revenue model 808 for widgets, another required revenue model 808 for gadgets, etc. An electronic market module 810 determines the current market price 812 for each product based on the required revenue model 808 for that product. For example, the current market price 812 for a gadget may be determined as the lowest price for the lowest number of gadgets as per one or more required revenue models 808 for the gadgets as given by one or more sellers 804. Alternatively, the current market price 812 may be determined based on additional shipping and handling costs, taxes, etc. Given that such additional costs are different for different users, in one implementation, the current market price 812 for each of the buyer 806 may be different from other buyers.

The electronic market module 810 presents the current market price 812 for one or more of the products to the buyers 806 and allows the buyers 806 to input one or more COPs 814 for particular products. For example, one of the buyers 806 may specify that he or she is willing to pay $10 for five widgets. The electronic market module 810 aggregates the COPs 814 from various buyers 806, determines an effective COP, and evaluates the effective COP in view of the required revenue models 808. Note that the required revenue models 808 change based on instantaneous sales and therefore, the electronic market module 810 evaluates the COPs 814 against current required revenue models 808. If a transaction is determined to be mutually agreeable between a collection of buyers 806 as per the effective COP and one or more sellers 804 as per their required revenue models 808, a transaction module 820 facilitates the transactions.

Note that in FIG. 8, one or more components of the exchange driven market system 800, such as the electronic market module 810, the transaction module 820, etc., are illustrated as separate modules, they may all be implemented by one computing system such as a server based computing system, a cloud based computing system, etc. The transaction module 820 communicates the product fulfillment information to the electronic market module 810 and to the sellers 808. In response, the electronic market module 810 updates various required revenue models 808, the current market price 812, etc.

While the exchange driven market system 800 is illustrated to be facilitating the transactions based on COPs 814 offered by the buyers 806, in an alternative implementation, a buyer 806 may select to purchase a product at the current market price 812 without providing any COPs, in which case the exchange driven market system 800 completes such transaction instantaneously or based on a preauthorization. Additionally, the exchange driven market system 800 may also select to preauthorize each of the buyers 806 upon receiving their COPs 814 such that if the COP results in a mutually agreeable transaction it can be consummated automatically.

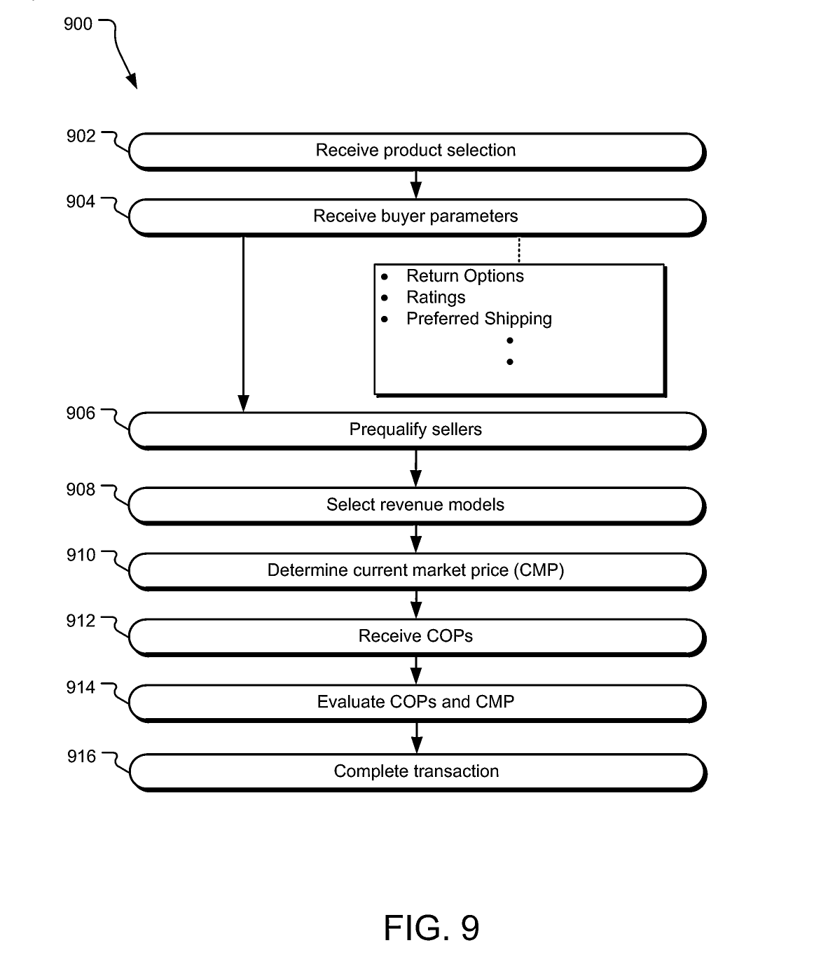

FIG. 9 illustrates a method of selecting a flowchart 900 for a method of prequalifying sellers based on one or more buyer preferences. An operation 902 receives a selecting of a product from a buyer, such as via a web browser interface, etc. An operation 904 receives one or more user preferences with respect to the purchase of the selected product. Such user preferences may include, for example, return options, ratings of the sellers, preferred shipping method, etc. A prequalification operation 906 prequalifies one or more sellers based on the buyer parameters. For example, if the buyer request for free shipping, only sellers that provide free shipping are selected. Similarly, if the buyer specifies a preference for sellers that are better business bureau rated, those sellers that do not have such ratings are disqualified. In one implementation, each of the buyers is required to provide various return policy options. Only those sellers that meet or exceed the return policy options requested by the buyers are prequalified. Examples of allowed return policies include, all sales final, allow return at sellers current offer price up to the paid price, allow return at price paid, etc.

Subsequently, a selecting operation 908 selects the required revenue models from the prequalified sellers and a determination operation 910 determines a CMP that is based on the required revenue models of the prequalified sellers. As a result, the CMP that is presented to a first buyer may be different from a CMP presented to a second buyer due to the different parameters selected by the first and the second buyers.

A receiving operation 912 receives the COPs from the buyers and an evaluating operation 914 evaluates the COPs in view of the CMP. As the CMP presented to various buyers is different, the evaluating operation normalizes or adjusts the COPs provided by the buyers to reflect such selections before completing the evaluation. If the effective COP meets a price level in the required revenue model, an operation 916 completes the transaction between one or more buyers and one or more sellers.

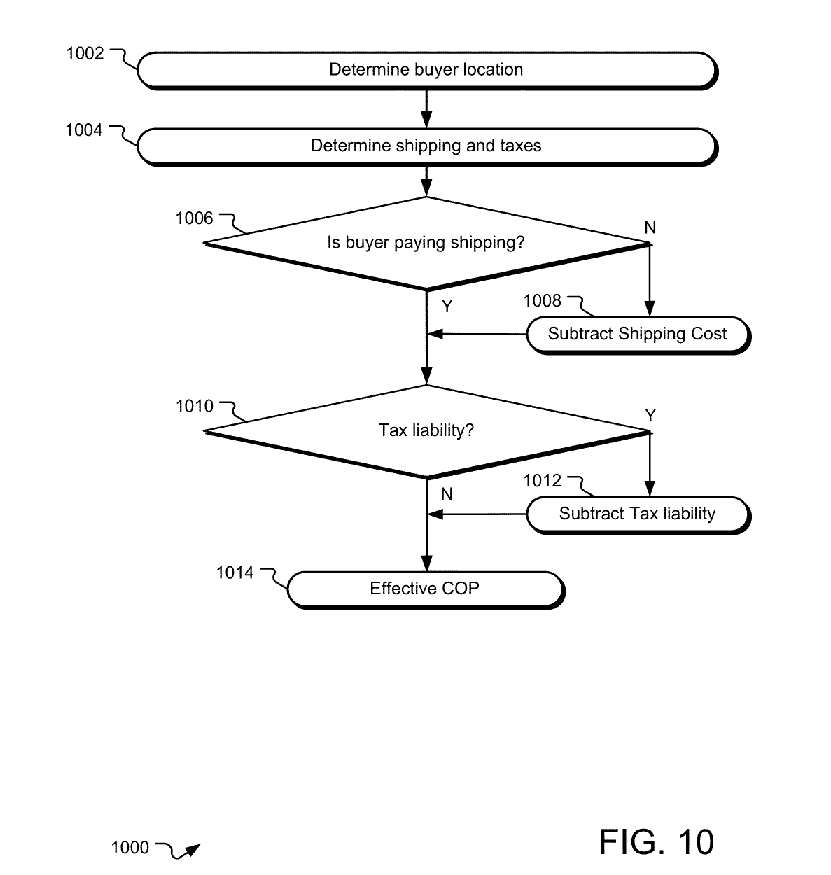

FIG. 10 illustrates a flowchart 1000 for generating an effective COP and an effective CMP for each seller based on a buyer's COPs. An operation 1002 determines the location of the buyer and based on that location, an operation 1004 determines the shipping costs and the effective tax liability. If an operation 1006 determines that the buyer is paying for the shipping cost, there is no adjustment to the COP. However, if the buyer is not paying the shipping cost, the COP is decreased by the amount of shipping cost at operation 1008. This is due to the fact that whatever is the COP offered by the buyer has to include the shipping costs. Similarly, if an evaluation operation 1010 determines that there is a tax liability on the seller, the COP is again decreased by the amount of tax liability at operation 1012. The resulting effective COP provided at 1014 can be compared with various price points in required revenue models from the sellers.

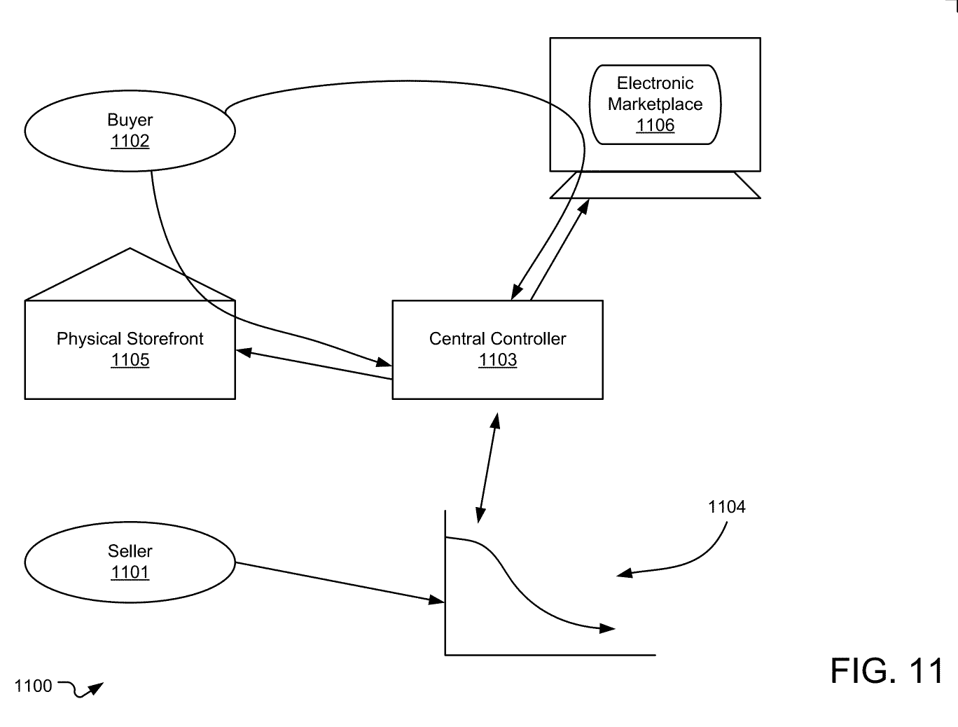

FIG. 11 illustrates a block diagram 800 that illustrates a seller's 801 required revenue model 1104 communicating with both an online marketplace 806 and the seller's physical storefront location(s) 1105 (and/or additional mediums of selling) via a central controller 1103 to instantaneously update the sellers current offering price for a particular product based on the sellers required revenue model 1104. In such an implementation, the required revenue model 1104 communicates with all of the markets in which a seller markets goods and/or services through the central controller 1103. Buyers 1102 communicate conditional offers for purchase to the marketplace 1106 via the central controller 1103 and/or purchase products from the marketplace 1106 at the current market price. Conditional offers for purchase (COPs) affect the previously seller-provided required revenue model 1104, which dictates the current offering price. In this implementation, the required revenue model 1104 also dictates the current offering price in a seller's physical storefront location 1105 via the central controller 1103 through the use of electronic displays, which display the current offering price for a particular product and/or service. Additionally, sales completed in the physical storefront location 1105 communicate with the required revenue model 1104 via the central controller 1103 in the same way that the marketplace 1106 communicates with the required revenue model 804 so that a required revenue model 1104 may essentially function as a business plan for the seller 1101 across all of the mediums by which the seller 1101 processes transactions of goods and/or services.

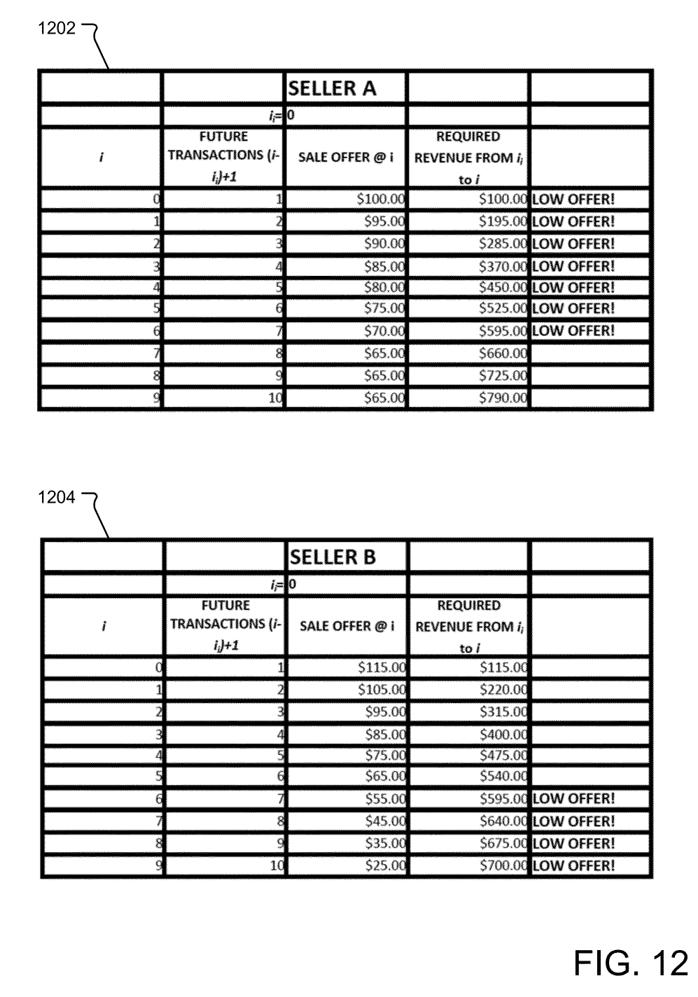

The methods and systems disclosed herein allows for an aggregation of transactions to occur at once. Aggregate transactions occur when a plurality of COPs creates a transaction opportunity, which is acceptable to the seller based on the previously stated required revenue model. When, at the same time, each individual transaction may not have been acceptable to the seller. The seller input for the required revenue model that dictates if and when aggregate transactions can occur is illustrated by required revenue models 1202 and 1204 for sellers A and B in FIG. 12.

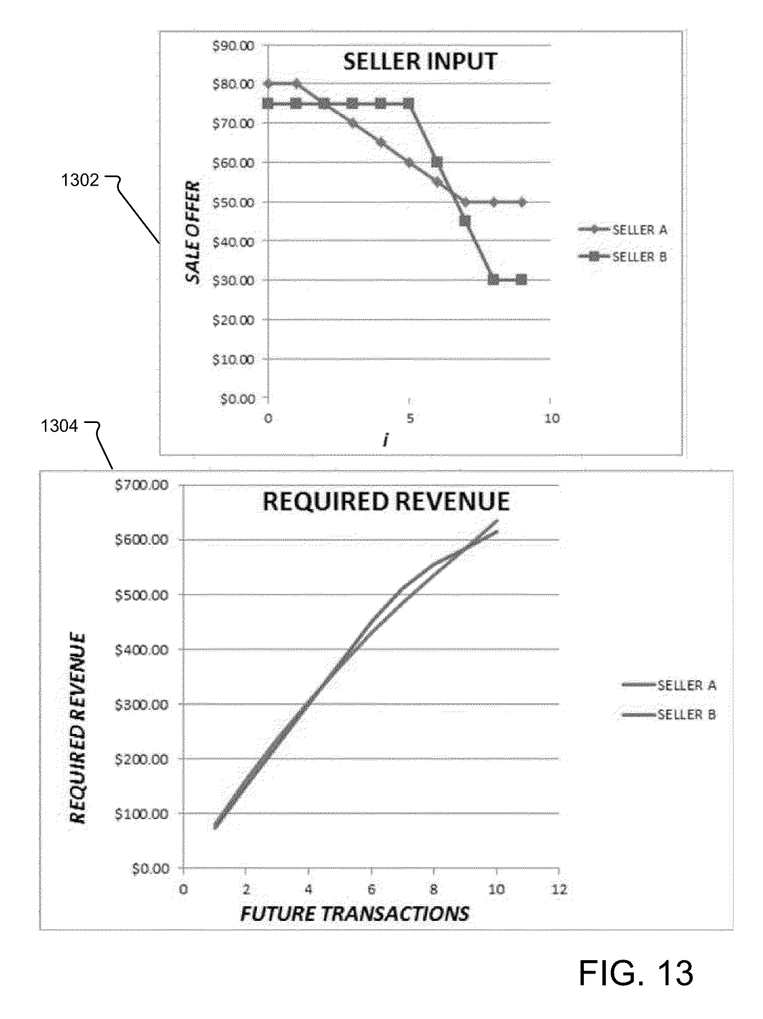

FIG. 13 illustrates the required revenue model consisting of a current single sale offer vs. number of previous sales in a given timeframe graph 1302, and a required revenue vs. number of future sales graph 1304 for sellers A and B. The required revenue graph is a running total of the revenue generated from each sale in the single sale offer vs. number of previous sales graph.

As COPs accumulate where such COPs cannot be filled by the standing required revenue models of potential sellers, the marketplace uses an algorithm to check and see if group transactions are possible. Specifically, the algorithm performs the following calculations:

Where n=quantity of COPs
1. Arrange COPs from high to low
2. Sum all COPs; if sum of COPs is greater than or equal to the required revenue for n future transactions, execute transactions.
3. If transactions have not yet been executed, Sum highest (n−1) bid prices, if sum of bid prices is greater than or equal to the required revenue for (n−1) future transaction, execute transactions.
4. If transactions have not yet been executed, Sum highest (n−2) bid prices, if sum of bid prices is greater than or equal to the required revenue for (n−2) future transaction, execute transactions.
5. If transactions have not yet been executed, continue summing decreasing quantities of the highest bid until the single highest bid is checked against the amount of required revenue for 1 future transaction.

In the event that multiple sellers are able to complete sales with buyers and mutually agreeable terms and for the same volume of sales, the market place uses a tie-breaking method to award sales to one of the sellers. In one implementation of the electronic market system, at the time of buyer input for a market price or a COP, the buyer has the option of inputting tie-breaking parameters. Tie-breaking parameters are parameters to which the buyer assigns a weighted importance. In the event of a tie, the ratings for each individual seller are weighted according to each buyer's assigned weights. The seller with the highest total score across all buyers is the seller that is rewarded the sale.

An implementation of the method and system disclosed herein includes the ability to inject cash into a transaction or aggregate of transactions to allow the transaction or aggregate of transactions to occur when it otherwise would not occur because a cash gap would have prevented buyer(s) and seller(s) from meeting mutually agreeable terms. If the fee charged for the volume of sales that is processed is greater than the injection of cash needed to complete a transaction or aggregate of transactions, then the decision to supplement this cash deficit is known to be a profitable decision for the electronic market place.

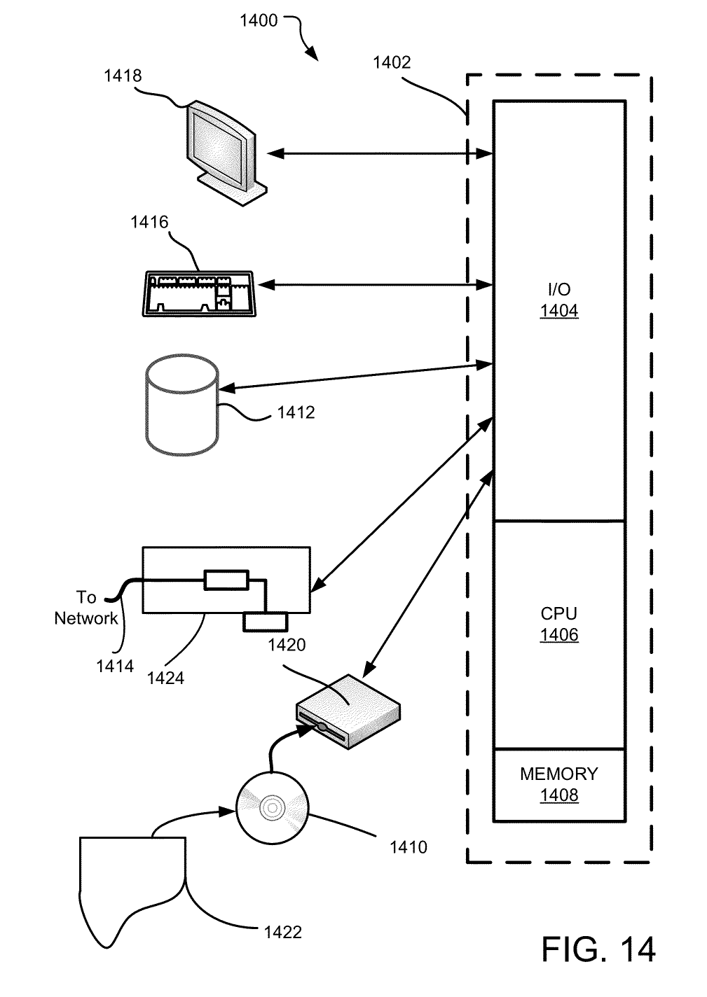

FIG. 14 illustrates an example computing system that can be used to implement one or more components of the exchange driven market system method and system described herein. A general-purpose computer system 1400 is capable of executing a computer program product to execute a computer process. Data and program files may be input to the computer system 1400, which reads the files and executes the programs therein. Some of the elements of a general-purpose computer system 1400 are shown in FIG. 14, wherein a processor 1402 is shown having an input/output (I/O) section 1404, a Central Processing Unit (CPU) 1406, and a memory section 1408. There may be one or more processors 1402, such that the processor 1402 of the computer system 1400 comprises a single central-processing unit 1406, or a plurality of processing units, commonly referred to as a parallel processing environment. The computer system 1400 may be a conventional computer, a distributed computer, or any other type of computer such as one or more external computers made available via a cloud computing architecture. The described technology is optionally implemented in software devices loaded in memory 1408, stored on a configured DVD/CD-ROM 1410 or storage unit 1412, and/or communicated via a wired or wireless network link 1414 on a carrier signal, thereby transforming the computer system 1400 in FIG. 14 to a special purpose machine for implementing the described operations.

The I/O section 1404 is connected to one or more user-interface devices (e.g., a keyboard 1416 and a display unit 1418), a disk storage unit 1412, and a disk drive unit 1420. Generally, in contemporary systems, the disk drive unit 1420 is a DVD/CD-ROM drive unit capable of reading the DVD/CD-ROM medium 1410, which typically contains programs and data 1422. Computer program products containing mechanisms to effectuate the systems and methods in accordance with the described technology may reside in the memory section 1404, on a disk storage unit 1412, or on the DVD/CD-ROM medium 1410 of such a system 1400, or external storage devices made available via a cloud computing architecture with such computer program products including one or more database management products, web server products, application server products and/or other additional software components. Alternatively, a disk drive unit 1420 may be replaced or supplemented by a floppy drive unit, a tape drive unit, or other storage medium drive unit. The network adapter 1424 is capable of connecting the computer system to a network via the network link 1414, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 1400 is connected (by wired connection or wirelessly) to a local network through the network interface or adapter 1424, which is one type of communications device. When used in a WAN-networking environment, the computer system 1400 typically includes a modem, a network adapter, or any other type of communications device for establishing communications over the wide area network. In a networked environment, program modules depicted relative to the computer system 1400 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory 1408 or other storage systems, such as disk storage unit 1412 or DVD/CD-ROM medium 1410 and/or other external storage device made available and accessed via a cloud computing architecture. Still further, some or all of the operations for the system for the exchange drive electronic commerce system disclosed herein may be performed by the processor 1402. In addition, one or more functionalities of the system disclosed herein may be generated by the processor 1402 and a user may interact with these GUIs using one or more user-interface devices (e.g., a keyboard 1416 and a display unit 1418) with some of the data in use directly coming from third party websites and other online sources and data stores via methods including but not limited to web services calls and interfaces without explicit user input.

Embodiments of the present technology are disclosed herein in the context of an electronic market system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application—and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method, comprising:
receiving a plurality of sale offers, each sale offer including required revenue values per volume values for a product;
determining an offered market price based on the plurality of sale offers;
displaying, using a computer interface, the offered market price to a plurality of buyers;
receiving from the plurality of buyers, using the computer interface, a plurality of conditional offers for purchases (COPs);
determining, using a computer processor, whether a combination of one or more of the plurality of COPs meets a combination of one or more of the required revenue values; and
completing a plurality of sales transactions, if the combination of one or more of the plurality of COPs meets the combination of one or more of the required revenue values.

2. The method of claim 1, wherein each COP specifies an offered purchase value for a volume of product purchase.

3. The method of claim 1, further comprising:
communicating a message of incomplete transaction, if the combination of one or more of the plurality of COPs does not meet the combination of one or more of the required revenue values.

4. The method of claim 1, wherein determining the offered market price further comprises determining the offered market price in consideration of at least one of shipping cost for the product and taxes for the product.

5. The method of claim 1, wherein receiving a plurality of required revenue values further comprises receiving a plurality of required revenue values from a plurality of sellers.

6. The method of claim 1, further comprising:
automatically arranging the plurality of COPs from high to low before determining whether a combination of the one or more of the plurality of COPs meets a combination of one or more of the required revenue values; and
selecting a combination of highest COPs that at least one of (1) meets a combination of one or more of the required revenue values, (2) generates the largest volume of sales, and (3) generates the largest amount of revenue.

7. The method of claim 1, wherein determining the offered market price further comprises:
calculating an additional buyer offer price based on the combination of one or more of the plurality of COPs and the combination of one or more of the required revenue values; and
displaying the additional buyer offer price to an additional buyer.

8. The method of claim 1, further comprising:
determining if the combination of one or more of the required revenue values includes at least two required revenue values from two different vendors, each of the two required revenue values being substantially similar; and
selecting one of the two different vendors based on a tie-breaking criterion provided by a buyer.

9. The method of claim 8, wherein the tie-breaking criterion provides for selecting a vendor that offers lowest sale price for a next unit of product following completion of the plurality of sales transactions.

10. The method of claim 1, further comprising adjusting the COPs based on at least one of sales tax payable and shipping costs payable.

11. The method of claim 1, wherein displaying the offered market price further comprises displaying the offered market price at a storefront display of one of a plurality of vendors providing one of the plurality of sale offers.

12. The method of claim 10, further comprising adjusting the one of the plurality of offers based on sale of the product at the storefront.

13. The method of claim 1, further comprising adjusting at least one of the plurality of offers based on returns of the product based on one of the plurality of sales transactions.

14. The method of claim 1, further comprising facilitating a plurality of sales transactions using capital from an intermediary, if the combination of one or more of the plurality of COPs does not meet a combination of one or more of the required revenue values.

15. The method of claim 1, further comprising facilitating a plurality of sales transactions by reducing intermediation fees for an intermediary, if the combination of one or more of the plurality of COPs does not meet a combination of one or more of the required revenue values.

16. One or more tangible computer-readable storage media storing computer executable instructions for performing a computer process on a computing system, the computer process comprising:
receiving a plurality of sale offers, each sale offer including required revenue values per volume values for a product;
determining an offered market price based on the plurality of sale offers;
displaying, using a computer interface, the offered market price to a plurality of buyers;
receiving from the plurality of buyers, using the computer interface, a plurality of conditional offers for purchases (COPs), wherein each COP specifies an offered purchase value for a volume of product purchase; and
completing a plurality of sales transactions, if the combination of two or more of the plurality of COPs meets the combination of one or more of the required revenue values.

17. The computer-readable storage media of claim 16, wherein the computer process further comprising:
if the combination of two or more of the plurality of COPs do not meet the combination of one or more of the required revenue values:
determining an additional offer price to an additional buyer based on the combination of two or more of the plurality of COPs and the combination of one or more of the required revenue values, wherein the additional offer price combined with the combination of two or more of the plurality of COPs meets the combination of one or more of the required revenue values; and
displaying the additional offer price to an additional buyer.

18. The computer-readable storage media of claim 17, wherein the computer process for determining an additional offer price further comprising determining an additional offer price using less than all of the two or more of the plurality of COPs.

19. The computer-readable storage media of claim 17, wherein the computer process for determining an additional offer price further comprising determining an additional offer price such that the an additional offer price is the minimum possible an additional offer price that results in the combination of the additional offer price and the combination of two or more of the plurality of COPs meets the combination of one or more of the required revenue values.

20. An exchange based market system, comprising:
a computer processor; and
a tangible computer memory communicatively connected to the computer processor, the computer memory configured to store one or more computer programs to:
determine an offered market price based on a plurality of sale offers, each sale offer including required revenue values per volume values for a product,
display, using a computer interface, the offered market price to a plurality of buyers,
receive from the plurality of buyers, a plurality of conditional offers for purchases (COPs), wherein each COP specifies an offered purchase value for a volume of product purchase,
determine, if the combination of two or more of the plurality of COPs do not meet the combination of one or more of the required revenue values, an additional offer price to an additional buyer based on the combination of two or more of the plurality of COPs and the combination of one or more of the required revenue values, wherein the additional offer price combined with the combination of two or more of the plurality of COPs meets the combination of one or more of the required revenue values,
receive an acceptance from the additional buyer for a purchase at the additional offer price, and
complete a plurality of sales transactions including a sale transaction with the additional buyer and one or more of the plurality of buyers.
